(19) United States
(12) Patent Application Publication
(10) Pub. No.: US 2006/0185445 A1
(43) Pub. Date: Aug. 24, 2006

(54) Multi-parameter shaft analyzer (MPSA)

(75) Inventors: Ray C. Delcher, Oxnard, CA (US); Mohsen Khoshnevisan, Newburg Park, CA (US); Aaron Schwartzbart, Winnetka, CA (US); Ira B. Goldberg, Thousand Oaks, CA (US)

Correspondence Address: INGRASSIA FISHER & LORENZ, P.C., 7150 E. CAMELBACK, STE. 325, SCOTTSDALE, AZ, 85251, US

(73) Assignee: The Boeing Company

(21) Appl. No.: 11/066,883

(22) Filed: Feb. 24, 2005

(51) Int. Cl. G01L 3/10

(52) U.S. Cl. 73/862.325

(57) ABSTRACT

Methods and apparatus are provided for measuring multiple operating parameters of a rotating shaft with a sensor. One embodiment of the apparatus comprises a sensor in close proximity to a matched pair of thumbnail depressions on the surface of a rotating shaft body. The thumbnail depressions enable the sensor to detect axial displacement and rotational speed of the shaft in addition to detecting radial displacement of the shaft body. Signal processing circuitry analyzes the sensor output data and computes separate values for the axial displacement, speed and radial displacement parameters. Additional filtering and signal processing techniques can be used to ascertain peak axial displacement, to reduce noise, and to compute other parameters, such as acceleration and power spectral density.

### TECHNICAL FIELD

The present invention generally relates to instrumentation for rotating machinery, and more particularly relates to instrumentation for analyzing rotating shaft performance.

### BACKGROUND

Many types of machinery including pumps, motors, generators and the like operate in conjunction with one or more rotating shafts. Conventional engines used in aerospace and other applications, for example, commonly include shafts that transfer mechanical energy from a motor or other power source to a propeller, fan or other load. Various types and sizes of rotating shafts are commonly used across a wide range of aerospace, transportation, industrial, governmental and other applications.

Frequently, it is desirable to monitor certain operating performance parameters (e.g. rotation speed, radial or axial displacement, etc.) of a rotating shaft. Typically, these performance parameters are measured by individual sensors dedicated to a particular parameter. One sensor, for example, might monitor radial displacement of the shaft while another sensor monitors axial displacement and/or a third sensor monitors speed, and so on. Sensors of this type are generally coupled magnetically, capacitively, or optically to a rotating shaft via instrumentation ports, which are typically in the form of openings in the machinery housing. As such, in order to measure multiple parameters (e.g., axial displacement, radial displacement, speed, etc.), each sensor is typically configured with a corresponding instrumentation port. The incorporation of multiple sensors and multiple instrumentation ports into rotating shaft machinery can add to the complexity of the machinery design, electrical circuitry, and manufacture, and may also increase the possibility of component failure and restrict the incorporation of sensor redundancy to ensure robustness.

In the case of high performance rotating shaft machinery such as rocket engines, the use of multiple sensors and corresponding instrumentation ports can be particularly problematic since the multiple sensors can adversely affect the size and weight of the engine, and may also become potential leakage points. For example, in a rocket engine for a space vehicle, combustion is typically affected by the interaction of a fuel turbo pump and an oxygen turbo pump. Each of these turbo pumps typically incorporates a shaft rotating at a very high speed (e.g., on the order of 30,000 to 40,000 revolutions per minute or more) in order to provide sufficient pressure for a desired level of combustion. The axial and radial displacements of a rotating shaft in this type of application can indicate the health and performance of the shaft. For example, axial displacements might relate to clutch movements, whereas periodic radial displacements can indicate certain types of vibrations such as those caused by bearing wear. Instrumentation systems for monitoring the parameters of rotating shafts in rocket engine turbo pumps are therefore typically used for engine development. As noted above, however, multiple instrumentation ports can be disadvantageous to an engine design with respect to complexity and reliability, thereby inhibiting measurements of this kind during flight. As such, it is generally desirable to configure such instrumentation to have minimal adverse effects on the machinery being monitored.

Accordingly, it is desirable to provide an instrumentation system that utilizes a reduced number of sensors for measuring multiple parameters relating to the performance or health of a rotating machine (e.g., a rocket engine turbo pump). In addition, it is desirable to provide a signal processing capability within the instrumentation system that can process and analyze multiple parameters from the output signals of the reduced number of sensors. Furthermore, other desirable features and characteristics of the present invention will become apparent from the subsequent detailed description and the appended claims, taken in conjunction with the accompanying drawings and the foregoing technical field and background.

### BRIEF SUMMARY

According to various exemplary embodiments, devices and methods are provided for measuring multiple parameters of a rotating shaft with one or more sensors. One embodiment comprises a rotating shaft configured with a pair of diametrically opposed depressions in the shaft body. A sensor is positioned in proximity to the rotating shaft depressions and is configured to generate an output signal related to movement of the rotating shaft and the depressions. A processor is configured to receive and analyze the sensor output signal and to determine multiple operating parameters of the rotating shaft.

### BRIEF DESCRIPTION OF THE DRAWINGS

The present invention will hereinafter be described in conjunction with the following drawing figures, wherein like numerals denote like elements, and

FIG. 1 is an exemplary illustration of a multiple sensor measurement configuration for a rotating shaft;

FIG. 2 is an exemplary block diagram of a rocket engine;

FIG. 3 is an illustration of an exemplary embodiment of a shaft with embedded thumbnails;

FIG. 4 is an illustration of an exemplary embodiment of a multi-parameter sensor and shaft configuration;

FIG. 5 is a graphical illustration of exemplary multi-parameter signal waveforms; and

FIG. 6 is a block diagram of an exemplary embodiment of a multi-parameter shaft analyzer system.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention pertain to the area of monitoring the performance and health of rotating shaft machinery such as pumps, turbines, and motors. Typically, the rotating shaft parameters of interest include radial and axial displacement and speed, as well as others. The conventional use of a dedicated sensor and corresponding instrumentation port for each individual parameter can increase the complexity of a rotating shaft device, and can potentially degrade the reliability of the device. Therefore, a system for monitoring multiple parameters of a rotating shaft with a reduced number of sensors and instrumentation ports can reduce the complexity and increase the reliability of the rotating shaft device.

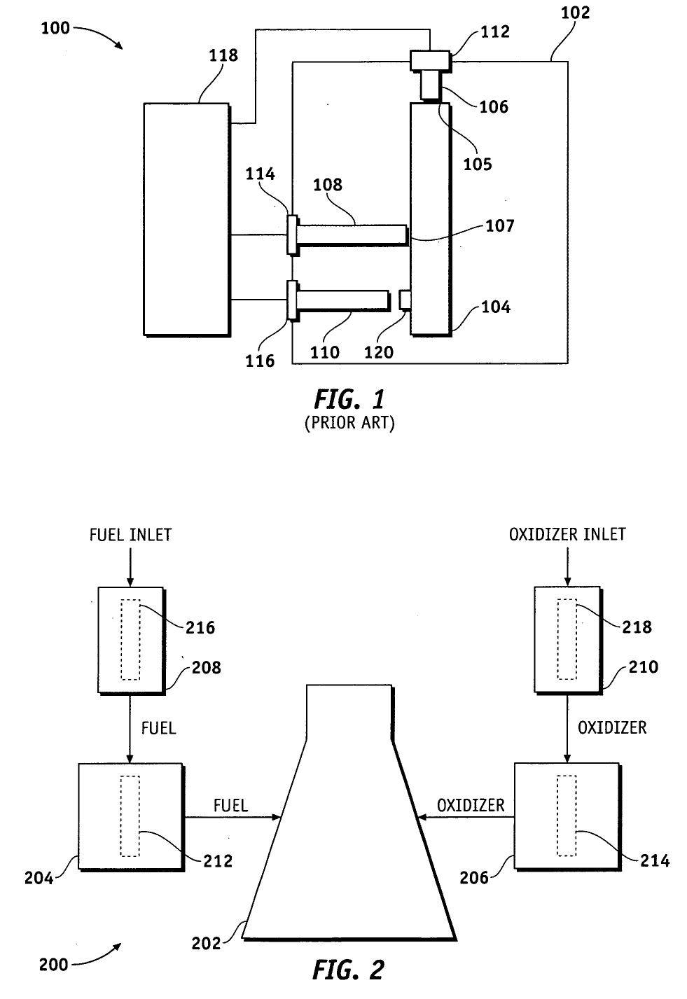

A conventional system 100 for monitoring rotating shaft parameters is illustrated in simplified form in FIG. 1. A machine 102 such as a pump or a motor typically contains a rotating shaft 104. A sensor 106 is typically positioned through an instrumentation port 112 to measure the axial displacement of an axial face 105 of shaft 104. Although sensor 106 is shown positioned coaxial to shaft 104 for conceptual purposes, axial displacement may be determined in practice against a flange of shaft 104 to allow for proper positioning of sensor 106 with respect to the power source, load and/or other mechanical components. FIG. 1 shows a second sensor 108 positioned through an instrumentation port 114 to measure the radial displacement of a radial face 107 of shaft 104, and a third sensor 110 is typically positioned through an instrumentation port 116 to measure the rotational speed of a nut, propeller or similar appendage 120 on shaft 104. Although appendage 120 is shown in exaggerated form in FIG. 1 for purposes of illustration, in practice appendage 120 would be placed, shaped, counter-balanced and/or otherwise configured to minimize imbalance or other disruption to shaft 100. The signal outputs of probes 106, 108 and 110 are generally processed and analyzed by a signal processing system 118.

As noted previously, multiple sensors and instrumentation ports can increase the complexity and degrade the reliability of a rotating machine system 100. In addition, the use of multiple sensors and instrumentation ports can affect the size, weight, and cost of the device being monitored. In an application such as a rocket engine, for example, it is generally desirable to minimize the complexity, size and weight of onboard monitoring equipment in the interest of maintaining as high a level of performance and reliability as possible. Therefore, minimizing the number of sensors and instrumentation ports can be particularly advantageous for a rocket engine application.

As illustrated in FIG. 2, an exemplary rocket engine configuration 200 includes a combustion system 202 (typically configured as a combustion chamber with nozzles and other associated components) and some quantity of associated turbo pumps (e.g., turbo pumps 204, 206, 208 and 210). Turbo pump 204 is typically a relatively high-pressure fuel pump that receives fuel from lower pressure turbo pump 208. The fuel, for example liquid hydrogen, is typically pumped by turbo pump 204 into combustion system 202. In similar fashion, turbo pump 206 is typically a relatively high-pressure oxidizer pump that receives oxidizer from lower pressure turbo pump 210. The oxidizer, for example liquid oxygen, is typically provided to generate a combustible mixture for combustion system 202.

As shown in the simplified embodiment of FIG. 2, each turbo pump 204, 206, 208, 210 typically incorporates a rotating shaft. That is, turbo pump 204 typically contains a rotating shaft 212, turbo pump 206 typically contains a rotating shaft 214, turbo pump 208 typically contains a rotating shaft 216, and turbo pump 210 typically contains a rotating shaft 218. To satisfy the typical high performance criteria of a rocket engine or other high performance device, the turbo pump shafts 212, 214, 216, 218 are generally rotated at very high speeds. For example, shafts 216 and 218 in turbo pumps 208 and 210, respectively, may operate in one embodiment at an approximate speed of about twenty four thousand (24,000) revolutions per minute (RPM), while shafts 212 and 214 in turbo pumps 204 and 206, respectively, may operate at an approximate speed of about thirty thousand to forty thousand (30,000 to 40,000) RPM. Other high performance rotating machinery may have lower speeds, typically ten thousand (10,000) RPM or less, and indeed the concepts described herein may be equivalently applied to entirely different environments with shafts rotating at any speed.

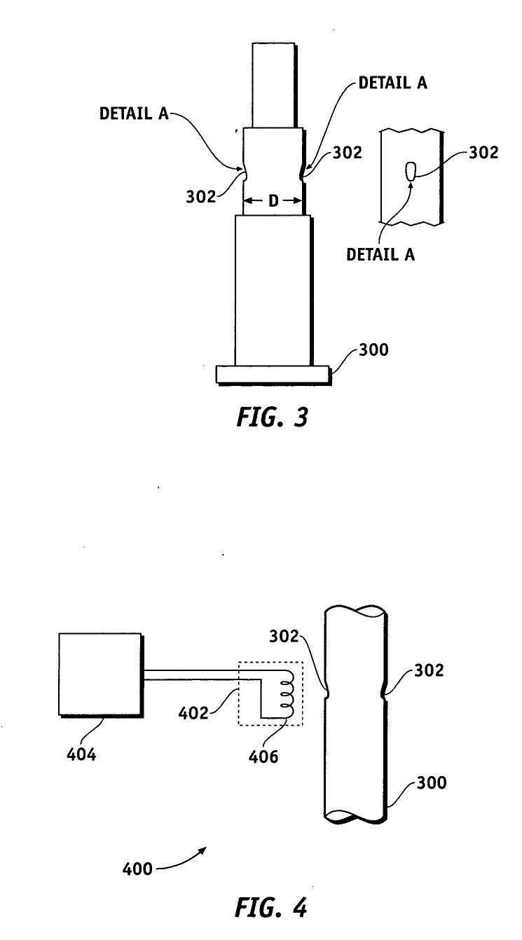

For the reasons stated above as well as others, it is generally desirable to minimize the complexity of the sensors and instrumentation ports used to monitor the performance of rotating shaft machinery. Accordingly, an exemplary embodiment of a method and apparatus for measuring multiple parameters with a reduced number of sensors (e.g. a single sensor) is illustrated in FIGS. 3 and 4. In FIG. 3, a shaft 300 is depicted with exemplary irregularities 302 (occasionally designated herein as “thumbnails” or “depressions”) in the body of shaft 300. It will be appreciated that thumbnail-type depressions are merely one type of shaft radial face irregularity 302 that can be used for multiple parameter measurements. Many other shapes and sizes of radial irregularities in a shaft surface may also provide a measurable edge or contour for a displacement sensor. The particular size, shape and positioning of a shaft body irregularity is generally determined by factors such as manufacturability, impact on shaft performance and reliability, sensor configuration and sensitivity, and so on.

Irregularities 302 are used in this embodiment to enable multiple shaft parameters (e.g. axial displacement, radial displacement, speed and/or the like) to be monitored with a single probe sensor. Depressions may be configured to any appropriate depth, as described more fully below. As noted above, the particular size, shape and depth configuration of this type of thumbnail or any other type of irregularity is generally dependent on the application criteria, required precision of the measurement, response time of the sensor and electronics and/or other factors. In general, for a shaft diameter (D) equal to approximately three (3) inches, for example, exemplary depressions 302 can be in the approximate range of about one-quarter (¼) inch to about one-half (½) inch long, and also in the approximate range of about one-quarter (¼) inch to about one-half (½) inch wide, as indicated in detail A. As such, the particular dimensions of depressions 302 will vary significantly from embodiment to embodiment. Further, although the term “depressions” is used herein, equivalent concepts could be applied to outcroppings or other irregularities in the surface of shaft 300.

As illustrated in FIG. 4, an exemplary embodiment of a single sensor multi-parameter shaft analyzer (MPSA) 400 includes shaft 300 with thumbnails 302 and a sensor 402 mounted through an instrumentation port (not shown) in close proximity to thumbnails 302. Typically, sensor 402 is connected to a power source/readout electronics 404. In general, sensor 402 may be an electromagnetic sensor or an optical sensor or any type of non-contact sensor capable of measuring physical displacement parameters.

One type of sensor generally used in rotating shaft applications is known as a variable inductance sensor (e.g., an “Eddy Current Probe”). This type of sensor uses the principal of electromagnetic induction as the basis for making measurements and various types are generally commercially available, such as displacement sensor KD-1925 from Kaman Instrumentation. In FIG. 4, sensor 402 is shown in a simplified single coil Eddy Current Probe configuration. In this exemplary embodiment, an alternating voltage is supplied from power source/readout electronics 404 to a conductor coil 406 within sensor 402, resulting in an alternating current within coil 406 that generates an electromagnetic field (not shown) in and around coil 406. This electromagnetic field increases as the alternating current rises to a maximum and collapses as the alternating current is reduced to zero. If another electrically conductive material such as shaft 300 (assuming shaft 300 is fabricated from a conductor material) is brought into close proximity with the changing electromagnetic field (i.e., exposed to the changing electromagnetic field), eddy currents will typically be induced in this second conductor (shaft 300). These induced eddy currents will typically vary in accordance with the proximity of shaft 300 to coil 406 (and in the FIG. 4 example, with the proximity of the contour of thumbnail 302 to coil 406) and will typically generate an electromagnetic field that interacts with the electromagnetic field generated by coil 406. This electromagnetic field interaction typically produces corresponding impedance variations in coil 406 that are representative of the proximity variations (displacements) of the contour of thumbnail 302 to coil 406. These impedance variations can be detected and amplified by circuitry within power source/readout electronics 404 and converted into output data.

It will be appreciated that other types of sensors may be used for shaft materials that are, e.g., primarily ferromagnetic or non-conducting. For example, a modified Eddy Probe or other type of magnetic sensor could be used with a ferromagnetic shaft, and, e.g., an optical sensor, such as those available from MTI Instruments, Inc., could be used for a shaft fabricated from a non-conducting material, as well as other materials. Similarly, a probe based on variations in capacitance is also available from MTI, and could be used instead of an electromagnetic sensor.

In the embodiment shown in FIGS. 3 and 4, the exemplary thumbnails 302 are shown to be approximately identical to each other and spaced approximately one hundred eighty (180) degrees apart on a circumferential plane of shaft 300 (i.e. on opposite ends of a diameter drawn through shaft 300). In alternate embodiments, any number of identical or non-identical thumbnails 302 could be used, each of which could be located at any relative position on shaft 300. Thumbnails 302 may be configured of any shape or size, for example, and/or may be formed to any appropriate depth. In embodiments wherein sensors 402 are Kaman sensors, for example, thumbnails 302 may be formed to a depth of about 0.01-0.06 inches (or about 30-180 micrometers) or so, although alternate embodiments may use significantly deeper or shallower depressions, or indeed may replace the depressions entirely with outcroppings or other irregularities in the surface of shaft 300. Further, thumbnails 302 may be placed closer together on the circumference of the shaft (e.g. at a radial distance of approximately 90-180 degrees or so) to allow placement of multiple redundant sensors 402 near shaft 300. Accordingly, while each sensor 402 may be capable of detecting multiple shaft parameters, certain embodiments may still incorporate multiple sensors 402 for redundancy or other purposes.

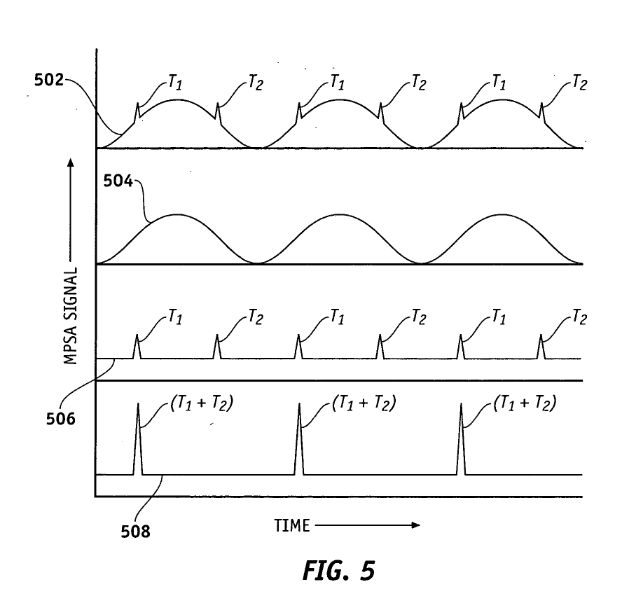

An exemplary signal waveform 502 that can be derived from the output data of exemplary sensor 402 and power source/readout electronics 404 is illustrated in simplified form in FIG. 5, where signal voltage is displayed on the vertical axis with respect to time on the horizontal axis. Each cycle of waveform 502 is shown to include two signal peaks T₁ and T₂, which represent the respective peak displacements of opposing thumbnails 302 during a single rotation of shaft 300. Referring again to the exemplary embodiment shown in FIG. 2, it may be assumed that shaft 212 in fuel turbo pump 204 can rotate at an approximate speed of up to sixty thousand (60,000) revolutions per minute, or about one thousand (1,000) revolutions per second. A typical carrier frequency for an Eddy Probe sensor such as the previously noted KD-1925 is approximately five hundred thousand (500,000) cycles per second. Therefore, an exemplary sensor 402 (FIG. 4) could operate at approximately five hundred (500) carrier cycles per shaft rotation. As such, for an exemplary shaft 300 circumference of approximately ten (10) inches and an approximate thumbnail 302 circumferential width of one-half (½) inch, the number of data points sensed for each of the two thumbnails 302 during a single shaft 300 rotation would be approximately twenty-five (25).

It is generally desirable to ascertain the peak height of the thumbnail 302 displacement data (e.g., T₁ and T₂) obtained from exemplary sensor 402 and power source/readout electronics 404. In one exemplary embodiment, a curve fitting technique can be used to determine the approximate peak of the thumbnail data points. An exemplary technique useful for this purpose involves a second or higher order polynomial curve fit to the data representing the approximate upper amplitude third of the measured thumbnail data points. Exemplary polynomial curve fitting techniques are described in the reference entitled “Data Reduction and Error Analysis for the Physical Sciences, 3^{rd} Ed.” by P. R. Bevington and K. D. Robinson, McGraw-Hill, 2003 (ISBN: 0072472278).

In FIG. 5, exemplary signal waveform 502 represents a composite of radial and axial displacement data where the displayed thumbnail signal peaks (T₁ and T₂) have been determined by curve fitting. The curve fitting reduces random noise by effectively averaging data from several data points and reduces quantization noise by implicitly providing the peak position, even if actual data points exist only on either side of the peak. As noted previously, radial displacement represents the transverse movement of shaft 300 relative to sensor 402 and axial displacement represents the longitudinal movement of an axial face of shaft 300 relative to sensor 402. In this exemplary embodiment, the measured proximity of the contour of thumbnail 302 typically provides longitudinal (axial) displacement data while the measured proximity of the main body of shaft 300 provides transverse (radial) displacement data. It will be appreciated that the rotating speed of shaft 300 can also be determined from the rotational periodicity of thumbnails 302.

In order to separate the radial and axial displacement components of composite waveform 502, a baseline radial displacement waveform 504 can be generated by power source/readout electronics 404 from data taken on either side of thumbnails 302 (i.e., from the body of shaft 300). If baseline radial displacement waveform 504 is subtracted from composite waveform 502, a difference waveform 506 will typically represent the axial displacement data, and may also contain a relatively small amount of “leakage” radial displacement noise. This residual radial displacement noise can distort the axial displacement data due to the typically small amplitude of the axial data derived from thumbnails 302. That is, thumbnails 302 are typically configured with a relatively shallow angle, e.g., approximately 6 degrees, in order to minimize the anomalies to shaft 300. That is, an exemplary thumbnail configuration approximately ½ inch long may only vary in depth from about 10 mils near one end to approximately 60 mils near the other end. As such, the axial displacement component of waveform 502 may be small relative to the radial displacement component since the axial displacement component is generally proportional to the contour depth differentials of thumbnails 302 as the rotating shaft is displaced longitudinally.

In order to minimize the effect of the radial displacement noise coincident with thumbnail peaks T₁ and T₂ in waveform 506, the signals represented by T₁ and T₂ in waveform 506 from each of the two opposing thumbnails 302 can be added algebraically. As a result, at least some of the radial leakage components from thumbnails 302 will tend to cancel each other out because they are typically 180 degrees out of phase with each other. On the other hand, the axial displacement components will typically combine in phase to approximately double in amplitude, as indicated by (T₁+T₂) in waveform 508. As such, a second order radial signal removal can be achieved, resulting in an improved signal-to-noise ratio of the axial displacement data.

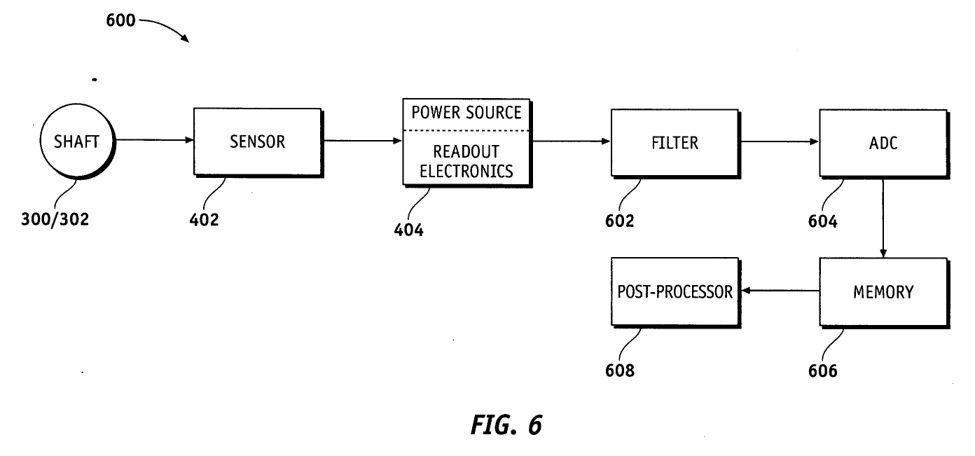

An exemplary embodiment of a multi-parameter shaft analyzer (MPSA) system 600 that incorporates the data processing features previously described is shown in block diagram form in FIG. 6. In this embodiment, rotating shaft 300 with thumbnails 302 is monitored by sensor 402 in conjunction with power source/readout electronics 404. A low-pass filter 602, such as an 8-pole Bessel filter, can be used to filter out unwanted signal noise at frequencies higher than the data rate of the analog output of power source/readout electronics 404. This noise can include the “carrier” signal for the Eddy current sensor and harmonics thereof. The filtered analog signal data is then typically converted to digital form by an analog-to-digital converter 604 such as a National Instruments 12-bit ADC Board. The digital data output from ADC 604 can then be stored in a memory device 606 that is associated with a post-processor 608. Memory device 606 can be any suitable digital storage device such as a hard drive or any other appropriate type of data storage. Post-processor 608 may be any type of microprocessor, micro-controller or other computing device capable of executing instructions in any computing language.

The data processing techniques described above, including curve fitting, radial baseline subtraction and thumbnail signal addition are typically performed by post-processor 608 using the signal data stored in memory 606. It will be appreciated that in addition to extracting axial displacement, radial displacement and speed parameters from sensor 402, post-processor 608 can also compute other parameters (e.g., acceleration, time derivative of acceleration “jerk”, and impulse, among others) from the signal data stored in memory 606, as well as from data that may be derived from other sensors. In addition, post-processor 608 can compute a power spectral density (PSD) plot of the radial displacement from the signal data stored in memory 606. In this embodiment, it is generally desirable to exclude the data from thumbnails 302 from the PSD processing of radial displacement as their inclusion can produce extraneous spurious frequency components. The resultant unevenly sampled radial displacement data points can be processed using a conventional Fast Fourier Transform (FFT) technique, only by including an interpolation of the missing data points, and thus the FFT approach is generally better suited for evenly spaced data samples, without gaps in the data. In the exemplary embodiment, a Lomb Periodogram processing technique is typically used in preference to FFT because the Lomb method weights the data on a “per point” basis rather than on a “per time interval” basis. A reference for the Lomb Periodogram process is entitled “Numerical Recipes in C” with subtitle “The Art of Scientific Computing, Second Edition”, by Press, Teukolsky, Vetterling, and Flannery, Cambridge University Press, pages 575-584.

Accordingly, the shortcomings of the prior art have been overcome by providing an improved system for measuring operating parameters of a rotating shaft. In contrast to the conventional approach of using individual sensors for measuring each corresponding parameter, the exemplary embodiment described herein uses a single sensor to measure multiple parameters. The exemplary embodiment typically incorporates radial irregularities such as thumbnail depressions on a rotating shaft surface to provide axial displacement and speed information to the sensor in addition to the radial displacement information provided by the shaft body. Signal processing techniques are typically used to ascertain the peak displacement data values and to separate the radial data from the axial data in addition to calculating the speed of the rotating shaft. The use of a multi-parameter sensor and associated instrumentation port in lieu of individual sensors and corresponding instrumentation ports can reduce the hardware complexity as well as the size and weight of a rotating shaft parameter measuring system. For high performance rotating machinery such as turbo pumps in rocket engines, a reduction in the complexity of the monitoring equipment will typically be advantageous with respect to size, weight and reliability.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function, arrangement, and shape of elements without departing from the scope of the invention as set forth in the appended claims and the legal equivalents thereof.

What is claimed is:

1. A system for measuring multiple operating parameters of a rotating shaft having an outer radial surface having at least one irregularity, the system comprising:
a sensor positioned in proximity to the at least one irregularity, the sensor configured to sense movement of the rotating shaft and the at least one irregularity and to generate a sensor output signal corresponding to the movement of the rotating shaft and the at least one irregularity; and
a processor configured to receive and analyze the sensor output signal, wherein the processor is configured to derive multiple operating parameters of the rotating shaft from the sensor output signal.

2. The system of claim 1 wherein the multiple operating parameters comprise axial displacement, radial displacement and speed, and wherein the axial displacement and speed parameters are derived from a contour of the at least one irregularity, and the radial displacement is derived from a regular outer radial surface of the rotating shaft.

3. The system of claim 1 wherein the at least one irregularity comprises two substantially identical depressions in the general shape of a thumbnail, each depression having a width and a length in the approximate range of one-fortieth ( 1/40) to one-twentieth ( 1/20) of the circumference of the rotating shaft body, the depressions being located at substantially 180 degrees from each other on an outer surface of the rotating shaft.

4. The system of claim 1 wherein the sensor is an electromagnetic probe.

5. The system of claim 1 wherein the sensor is an optical probe.

6. The system of claim 1 wherein the sensor is a capacitive probe.

7. The system of claim 1 further comprising a pre-processing low pass filter configured to reduce noise components from the output signal of the sensor.

8. The system of claim 7 wherein the pre-processing filter is a multiple-pole Bessel low pass filter.

9. The system of claim 1 further comprising an additional sensor configured to sense operating parameters of the rotating shaft, and to generate corresponding output signals to the processor.

10. A method of determining multiple operating parameters of a rotating shaft from a sensor in proximity to at least one irregularity of the rotating shaft, comprising the steps of:
generating an output signal from the sensor related to movement of the rotating shaft with the at least one irregularity, wherein the output signal comprises a combination of radial and axial displacement data and speed data;
determining a peak value of the combination of radial and axial displacement data;
separating the radial displacement data from the axial displacement data; and
processing the radial displacement data, the axial displacement data and the speed data to determine radial displacement characteristics, axial displacement characteristics and speed characteristics of the rotating shaft.

11. The method of claim 10 wherein the determining step comprises fitting a curve to a portion of the combination of radial and axial displacement data, and fitting the curve to sections of data taken outside the at least one irregularity, wherein coefficients are obtained for determining a radial displacement baseline.

12. The method of claim 11 wherein the portion of the combination of radial and axial displacement data is approximately the highest amplitude third of the radial and axial displacement data points.

13. The method of claim 11 wherein the curve fitting is based on a second order polynomial curve fitting technique.

14. The method of claim 10 wherein the separating step comprises subtracting the radial displacement baseline from the combination of radial displacement data and axial displacement data.

15. The method of claim 14 wherein the separating step further comprises reducing radial displacement noise in the axial displacement data.

16. The method of claim 10 wherein the processing step further comprises determining acceleration characteristics of the rotating shaft from the speed data.

17. The method of claim 10 wherein the processing step further comprises generating a power spectral density plot from the radial displacement data.

18. The method of claim 17 wherein the power spectral density plot is generated in accordance with a Lomb Periodogram technique.

19. The method of claim 10 wherein one or more additional sensors in proximity to the rotating shaft generate corresponding output signals related to the operating parameters of the rotating shaft.

20. The method of claim 19 wherein the output signals from the one or more additional sensors are processed to determine operating characteristics of the rotating shaft.
